(19) United States
(12) Patent Application Publication
(10) Pub. No.: US 2016/0189879 A1
(43) Pub. Date: Jun. 30, 2016

(54) Dye-Sensitized Solar Cell Structure and Manufacturing Method Thereof

(71) Applicant: National Kaohsiung University of Applied Sciences, Kaohsiung (TW)

(72) Inventors: Shih-Kun Liu, Kaohsiung (TW); Chin-Hsiang Chen, Kaohsiung (TW); Yun-Ju Chu, Kaohsiung (TW); Yi-Wei Wang, Kaohsiung (TW); Yu-Hsuan Tsai, Kaohsiung (TW)

(21) Appl. No.: 14/861,873

(22) Filed: Sep. 22, 2015

(30) Foreign Application Priority Data
Dec. 29, 2014 (TW) 103146143

(51) Int. Cl. H01G 9/20

(52) U.S. Cl. CPC H01G 9/2059

(57) ABSTRACT

A dye-sensitized solar cell includes a first substrate, a first electrode, a semiconductor layer, a thin photosensitive dye layer, an electrolyte layer, a second electrode and a second substrate. The first electrode is formed on the first substrate as a working electrode, the semiconductor layer is formed on the first electrode and the thin photosensitive dye layer is formed on the semiconductor layer by ultrasound-treating the semiconductor layer which is immersed in a photosensitive dye solution. The second electrode is formed on the second substrate as a counter electrode and the electrolyte layer is disposed between the semiconductor layer and the second electrode.

### BACKGROUND OF THE INVENTION

1. Field of the Invention

The present invention relates to a dye-sensitized solar cell (DSSC) structure and manufacturing method thereof. Particularly, the present invention relates to the dye-sensitized solar cell structure and manufacturing method thereof utilizing ultrasound treatment to reduce an immersion time of a semiconductor layer in a photosensitive dye solution and to further improve the uniformity of a thin photosensitive dye layer.

2. Description of the Related Art

Taiwanese Patent Pub. No. 200919742, entitled “Dye-Sensitized Solar Cell Manufacturing Method,” discloses a method, including the steps of: 1. forming a semiconductor layer on a first conducting substrate; 2. pre-treating a surface of the semiconductor layer with a treatment process; 3. after the surface of the semiconductor layer being pretreated, coating a thin photosensitive dye layer on the pretreated surface of the semiconductor layer; 4. injecting an electrolyte between the thin photosensitive dye layer and a second conducting substrate; 5. packaging the second conducting substrate above the electrolyte.

Prior to coating the thin photosensitive dye layer, the pretreatment process of the surface of the semiconductor layer includes the steps of: 1. providing an ultrasound oscillator in an aqua regia solution; 2. immerging the first conducting substrate formed with the semiconductor layer in the aqua regia solution; 3. operating the ultrasound oscillator to oscillate the aqua regia solution for cleaning the surface of the semiconductor layer; 4. drawing out the first conducting substrate from the aqua regia solution; 5. water-washing the semiconductor layer and the first conducting substrate; and 6. drying the semiconductor layer and the first conducting substrate for forming a thin photosensitive dye layer thereon.

In addition, the surface of the semiconductor layer can be selectively pretreated by other surface treatment processes, including a plasma surface treatment, an ultraviolet surface treatment and an ultraviolet and ozone surface treatment. Furthermore, the thin photosensitive dye layer can be selectively formed by spin-coating, screen printing, inkjet printing and immersion manners.

In fact, the thin photosensitive dye layer is simply formed on the pretreated surface of the semiconductor layer by spin-coating or immersion manner. However, in forming the thin photosensitive dye layer the immersion method has no additional approach to accelerate the deposition of the thin photosensitive dye layer or homogenize the thin photosensitive dye layer to be formed onto the surface of the semiconductor layer. Disadvantageously, the simply immersion method described in Taiwanese Patent Pub. No. 200919742 will result in prolonging the immersion time of the semiconductor layer in the photosensitive dye solution and a total process time in manufacturing the dye-sensitized solar cell.

In addition to the 24-hour immersion method, there is an approach of increasing a concentration or an operational temperature for increasing a diffusion flux of the photosensitive dye to be deposited on the surface of the semiconductor layer. Furthermore, an increase of the concentration or the operational temperature of the photosensitive dye solution contained in an airtight container can be utilized to accelerate the photosensitive dye to be deposited on the surface of the semiconductor layer. In spin-coating operation, the high-speed stream of the photosensitive dye solution generated by a spin disk is utilized to impact against the surface of the semiconductor layer (TiO₂ layer) for accelerating the entire process.

However, in order to shorten the process time or improve the quality of the thin photosensitive dye layer, there is a need of providing an immersion method for accelerating the immersive deposition process or homogenizing the thin photosensitive dye layer to be deposited on the surface of the semiconductor layer. The above-mentioned patent is incorporated herein by reference for purposes including, but not limited to, indicating the background of the present invention and illustrating the situation of the art.

As is described in greater detail below, the present invention provides a dye-sensitized solar cell structure and manufacturing method thereof. A working electrode is formed with a semiconductor layer which is immersed in a photosensitive dye solution and is further treated by ultrasound to accelerate the immersive deposition process and homogenize a thin photosensitive dye layer to be formed on a surface of the semiconductor layer. Advantageously, the present invention can rapidly and homogenously form the thin photosensitive dye layer on the surface of the semiconductor layer in such a way as to mitigate and overcome the above-mentioned problem of the conventional immersion method.

### SUMMARY OF THE INVENTION

The primary objective of this invention is to provide a dye-sensitized solar cell structure and manufacturing method thereof. A semiconductor layer of a working electrode is immersed in a photosensitive dye solution and is further treated by ultrasound to form a thin photosensitive dye layer, thereby reducing an immersion time of the semiconductor layer in the photosensitive dye solution and improving the uniformity of the thin photosensitive dye layer. Advantageously, the dye-sensitized solar cell structure and manufacturing method of the present invention is successful in reducing the fabrication time of forming the thin photosensitive dye layer and enhancing the quality of the thin photosensitive dye layer.

The dye-sensitized solar cell structure in accordance with an aspect of the present invention includes:

a first substrate;

a second substrate corresponding to the first substrate;

a first electrode layer formed on the first substrate to provide a working electrode;

a second electrode layer formed on the second substrate to provide a counter electrode;

a semiconductor layer formed on the first electrode layer;

at least one thin photosensitive dye layer formed on a surface of the semiconductor layer; and

an electrolyte layer provided between the semiconductor layer and the second electrode layer;

wherein the surface of the semiconductor layer is treated a predetermined time by ultrasound in forming the thin photosensitive dye layer on the surface of the semiconductor layer.

In a separate aspect of the present invention, the semiconductor layer is immersed in a photosensitive dye solution when the surface of the semiconductor layer is treated by the ultrasound.

In a further separate aspect of the present invention, the thin photosensitive dye layer is homogenized by the ultrasound treatment to form a homogenized layer.

In yet a further separate aspect of the present invention, a photosensitive material of the thin photosensitive dye layer is sodium copper chlorophyllin.

The manufacturing method of the dye-sensitized solar cell in accordance with an aspect of the present invention includes:

providing a first substrate on which to form a first electrode layer as a working electrode;

forming a semiconductor layer on the first electrode layer;

forming at least one thin photosensitive dye layer on the semiconductor layer by ultrasound-treating a surface of the semiconductor layer with a predetermined time, thereby facilitating deposition of a photosensitive material on the surface of the semiconductor layer;

providing a second substrate on which to form a second electrode layer as a counter electrode; and

providing an electrolyte layer between the semiconductor layer and the second electrode layer.

In a separate aspect of the present invention, the predetermined time ranges between five to thirty minutes.

In a further separate aspect of the present invention, the semiconductor layer is immersed in a photosensitive dye solution when the surface of the semiconductor layer is treated by the ultrasound.

In yet a further separate aspect of the present invention, the photosensitive dye solution is made from a mixture of sodium copper chlorophyllin and deionized (DI) water.

In yet a further separate aspect of the present invention, a molar concentration of the photosensitive dye solution is 0.004M.

In yet a further separate aspect of the present invention, the ultrasound is converted into mechanical waves to generate tiny bubbles in the photosensitive dye solution which impact the surface of the semiconductor layer.

In yet a further separate aspect of the present invention, a large working area of the thin photosensitive dye layer is formed on the semiconductor layer.

In yet a further separate aspect of the present invention, another thin photosensitive dye layer is further formed on the thin photosensitive dye layer.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic view of a dye-sensitized solar cell structure in accordance with a preferred embodiment of the present invention.

FIG. 2 is a flowchart of a manufacturing method of the dye-sensitized solar cell in accordance with a preferred embodiment of the present invention.

FIG. 3 is a chart illustrating light-to-electric energy conversion efficiencies of dye-sensitized solar cells in relation to resonant time of ultrasound applied in the manufacturing method of the dye-sensitized solar cells in accordance with a first preferred embodiment of the present invention.

FIG. 4 is a chart illustrating operating current densities in relation to operating voltages of the dye-sensitized solar cells in accordance with the first preferred embodiment of the present invention.

FIG. 5 is a chart illustrating light-to-electric energy conversion efficiencies of dye-sensitized solar cells in relation to resonant time of ultrasound applied in the manufacturing method of the dye-sensitized solar cells in accordance with a second preferred embodiment of the present invention.

FIG. 6 is a chart illustrating operating current densities in relation to operating voltages of the dye-sensitized solar cells in accordance with the second preferred embodiment of the present invention.

### DETAILED DESCRIPTION OF THE INVENTION

It is noted that a dye-sensitized solar cell structure and a manufacturing method thereof in accordance with the preferred embodiment of the present invention can be applicable to various devices of dye-sensitized solar cells and various photosensitive materials and solution thereof, which are not limitative of the present invention.

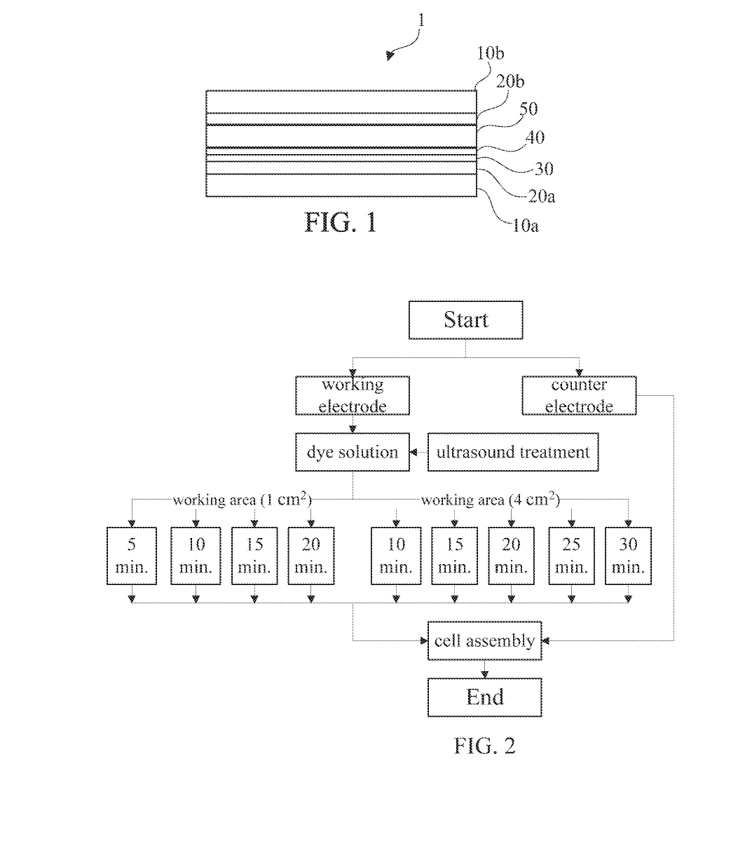

FIG. 1 shows a schematic view of a dye-sensitized solar cell structure in accordance with a preferred embodiment of the present invention. Referring now to FIG. 1, the dye-sensitized solar cell structure in accordance with the preferred embodiment of the present invention includes a sandwich structure of six or more layers, which are not limitative of the present invention. The dye-sensitized solar cell 1 includes a first substrate 10a, a first electrode layer 20a, a semiconductor layer 30, a thin photosensitive dye layer 40, an electrolyte layer 50, a second electrode layer 20b and a second substrate 10b which are arranged in order.

With continued reference to FIG. 1, the first substrate 10a and the second substrate 10b are selected from transparent plates or semi-transparent plates, including glass plates, plastic plates or other plates made of similar or dissimilar materials for example. In assembly, the first substrate 10a and the second substrate 10b are correspondingly disposed at opposite sides or other suitable positions of the dye-sensitized solar cell 1.

With continued reference to FIG. 1, the first electrode layer 20a is formed on the first substrate 10a and is performed as a working electrode of the dye-sensitized solar cell 1. The first electrode layer 20a is made of various metal materials, including gold, silver, copper, aluminum or platinum for example, or various metallic oxide materials, including indium tin oxide (ITO) or other transparent metallic oxide materials for example.

FIG. 2 shows a flowchart of a manufacturing method of the dye-sensitized solar cell, depicted in FIG. 1, in accordance with a preferred embodiment of the present invention. Referring to FIGS. 1 and 2, the manufacturing method of the dye-sensitized solar cell 1 of the preferred embodiment of the present invention includes the step of: providing the first substrate 10a on which to suitably form the first electrode layer 20a which is operated as at least one of the working electrodes.

With continued reference to FIGS. 1 and 2, the manufacturing method of the dye-sensitized solar cell 1 of the preferred embodiment of the present invention includes the step of: forming the semiconductor layer 30 on the first electrode layer 20a by suitable manners. By way of example, the semiconductor layer 30 can be formed by various plating methods, including physical vapor deposition (vapor deposition or vacuum sputter) or chemical vapor deposition, various coating method, including screen printing, spin-coating or inkjet printing. The semiconductor layer 30 can be formed from a porous nano-scale membrane, TiO₂ semiconductor for example.

Referring back to FIG. 1, the semiconductor layer 30 can be further made of various inorganic semiconductor materials, including various metallic oxides or complex metallic oxides, which are selected from titanium dioxide (TiO₂), zinc oxide (ZnO), cadmium oxide (CdO), tin oxide (SnO₂) or mixtures thereof.

Referring again to FIGS. 1 and 2, the manufacturing method of the dye-sensitized solar cell 1 of the preferred embodiment of the present invention includes the step of: forming at least one thin photosensitive dye layer 40 (or a plurality of thin photosensitive dye layers 40) on the semiconductor layer 30 suitably immersed in a photosensitive dye solution by continuously or discontinuously ultrasound-treating a surface of the semiconductor layer 30 with a predetermined resonant time. Advantageously, the deposition rate of the photosensitive material on the surface of the semiconductor layer 30 is enhanced by ultrasound such that the immersive deposition process is accelerated and the quality of the thin photosensitive dye layer 40 is homogenized. In a preferred embodiment, the power and the predetermined resonant process time of ultrasound must be controlled since an exceed power and resonant process time of ultrasound will result in damaging (e.g. penetrating through) the semiconductor layer 30 or peeling off the semiconductor layer 30 from the first electrode layer 20a.

With continued reference to FIGS. 1 and 2, by way of example, the photosensitive dye solution is made from a mixture of sodium copper chlorophyllin (SCC) and deionized water with a molar concentration of 0.004M. In another embodiment, the ultrasound is converted into mechanical waves to generate tiny bubbles in the photosensitive dye solution. The tiny bubbles are suitable for impacting a large-scale working area of the surface of the semiconductor layer 30. Advantageously, the semiconductor layer 30 and the thin photosensitive dye layer 40 can be fabricated to form a large working area for the dye-sensitized solar cell 1.

Referring again to FIG. 1, by way of example, the thin photosensitive dye layer 40 is formed by immersive deposition of the photosensitive material on the surface of the semiconductor layer 30. The material of the thin photosensitive dye layer 40 is selected from sodium copper chlorophyllin or other similar materials. In light energy conversion, the electrons of the photosensitive compounds will be transitioned from a ground state or a highest occupied molecular orbit (HOMO) to an excited state or a lowest unoccupied molecular orbit (LUMO) after the photosensitive compounds of the thin photosensitive dye layer 40 absorb light energy. Furthermore, the photosensitive compounds and inorganic semiconductors of the semiconductor layer 30 are chemically bonded. The excited electrons of the photosensitive compounds will be rapidly injected into a conduction band of the semiconductor layer 30 and the photosensitive compounds will be oxidized in the process. Moreover, the electrons are transported through the semiconductor layer 30 and the first electrode 20a for supplying a current from the dye-sensitized solar cell 1. Consequently, the electrons move through the load (not shown in FIG. 1), and reach the second electrode 20b. At the second electrode 20b, the electrons reduce the redox mediator located in the electrolyte layer 50 of the dye-sensitized solar cell 1. Finally, the redox mediator diffuses to meet and regenerate oxidized photosensitive compounds.

Still referring again to FIG. 1, by way of example, the second electrode layer 20b, similar to the first electrode layer 20a, is formed on the second substrate 10b and is operated as a counter electrode. The second electrode layer 20b is also made of various metal materials, including gold, silver, copper, aluminum or platinum for example, or various metallic oxide materials, including indium tin oxide (ITO) or other transparent metallic oxide materials for example.

Referring again to FIGS. 1 and 2, the manufacturing method of the dye-sensitized solar cell 1 of the preferred embodiment of the present invention includes the step of: providing the second substrate 10b on which to suitably form the second electrode layer 20b which is operated as at least one of the counter electrodes, as best shown in the right side in FIG. 2.

Still referring to FIGS. 1 and 2, the manufacturing method of the dye-sensitized solar cell 1 of the preferred embodiment of the present invention includes the step of: providing the electrolyte layer 50 between the thin photosensitive dye layer 40 and the second electrode layer 20b for supplying electrolytes between the thin photosensitive dye layer 40 and the second electrode layer 20b. By way of example, the electrolyte layer 50 is selected from liquid electrolyte or solid electrolyte according to the needs.

Referring again to FIG. 1, the electrolyte materials of the electrolyte layer 50 are performed as hole-transport materials (HTM) in the dye-sensitized solar cell 1. At the second electrode 20b, the electrons reduce the redox mediator located in the electrolyte layer 50. The redox mediator diffuses to meet and regenerate oxidized photosensitive compounds. Meanwhile, the surface of the counter electrode of the second electrode layer 20b has a catalytic material (e.g. platinum (Pt)) where the electrolyte layer 50 receives the electrons which are catalyzed for reductive reaction of the thin photosensitive dye layer 40.

FIG. 3 shows a chart of data illustrating light-to-electric energy conversion efficiencies of dye-sensitized solar cells in relation to resonant time of ultrasound applied in the manufacturing method of the dye-sensitized solar cells in accordance with a first preferred embodiment of the present invention. Referring to FIGS. 2 and 3, the manufacturing method of the dye-sensitized solar cell 1 in accordance with a first preferred embodiment of the present invention is applied on 1 cm² working area with the resonant time of ultrasound for 5, 10, 15 and 20 minutes to obtain the data of energy conversion efficiencies, as presented in Table 1, comparing with the conventional method of 24-hour immersion in the photosensitive dye solution, as presented in Table 2.

TABLE 1
Characteristics of the dye-sensitized solar cell in accordance with
the first preferred embodiment of the present invention

| | CONC | Time | Size | Counter | Jsc | Voc | | η |
|---|---|---|---|---|---|---|---|---|
| Dye material | (M) | (min) | (cm²) | electrode | (mA/cm²) | (V) | FF | (%) |
| DI water:SCC | 0.004 | 5 | 1 | Pt | 0.50 | 0.43 | 0.44 | 0.093 |
| DI water:SCC | 0.004 | 10 | 1 | Pt | 1.09 | 0.44 | 0.55 | 0.264 |
| DI water:SCC | 0.004 | 15 | 1 | Pt | 0.64 | 0.41 | 0.41 | 0.108 |
| DI water:SCC | 0.004 | 20 | 1 | Pt | 0.40 | 0.43 | 0.49 | 0.085 |

TABLE 2
Characteristics of the dye-sensitized solar cell manufactured by
the conventional method of 24-hour immersion

| | CONC | Immersion | Size | Counter | Jsc | Voc | | η |
|---|---|---|---|---|---|---|---|---|
| Dye material | (M) | (hr) | (cm²) | electrode | (mA/cm²) | (V) | FF | (%) |
| DI water:SCC | 0.004 | 24 | 1 | Pt | 0.98 | 0.45 | 0.51 | 0.225 |

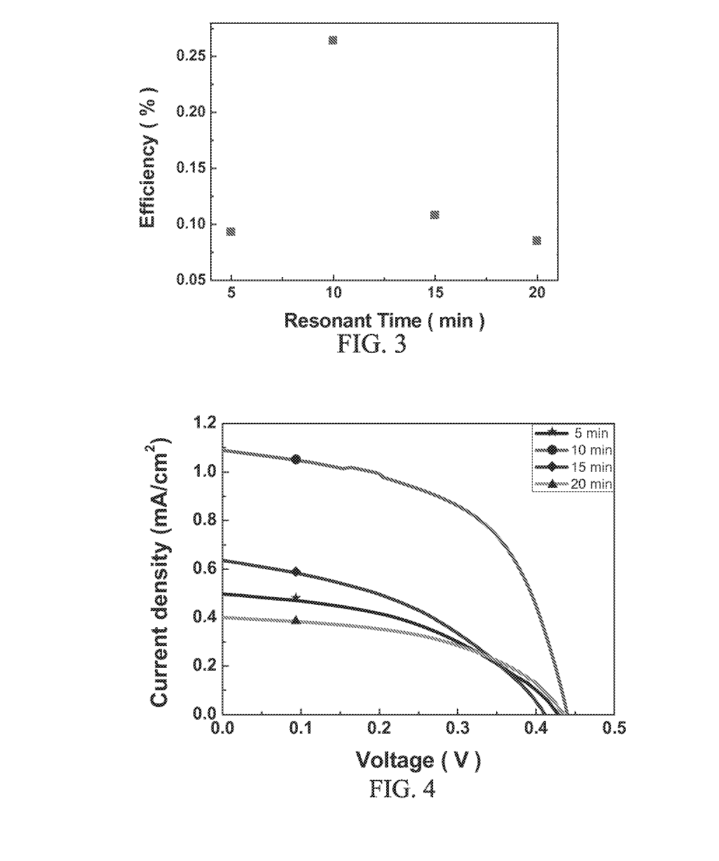

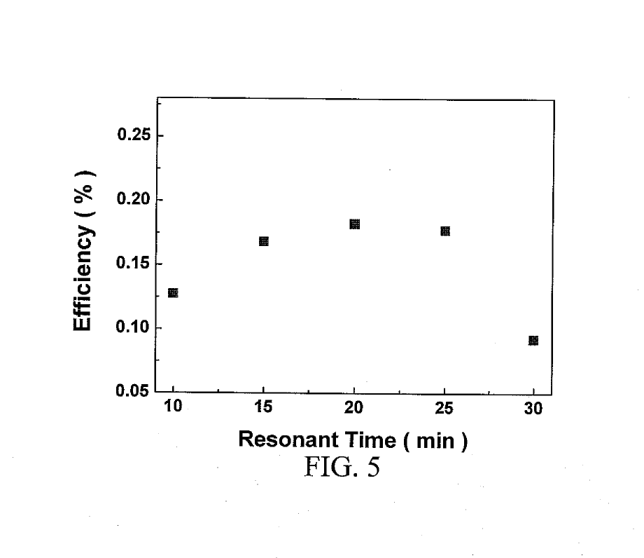

FIG. 4 shows a chart illustrating operating current densities in relation to operating voltages of the dye-sensitized solar cells in accordance with the first preferred embodiment of the present invention. Referring to FIGS. 1, 2 and 4, in forming the thin photosensitive dye layer 40, the 1 cm² working area of the first electrode layer 20a and the semiconductor layer 30 of the dye-sensitized solar cell 1 is treated by ultrasound for 5, 10, 15 and 20 minutes, respectively. The characteristics of operating current densities in relation to operating voltages of the dye-sensitized solar cell 1 are four curves as best shown in FIG. 4. Short circuit current densities (Jsc) and open circuit voltages (Voc) for the dye-sensitized solar cell 1 can be extracted from the four curves in FIG. 4 and the data are presented in Table 1.

FIG. 5 is a chart of data illustrating light-to-electric energy conversion efficiencies of dye-sensitized solar cells in relation to resonant time of ultrasound applied in the manufacturing method of the dye-sensitized solar cells in accordance with a second preferred embodiment of the present invention. Referring to FIGS. 2 and 5, the manufacturing method of the dye-sensitized solar cell 1 in accordance with a second preferred embodiment of the present invention is applied on 4 cm² working area with the resonant time of ultrasound for 10, 15, 20, 25 and 30 minutes to obtain the data of energy conversion efficiencies, as presented in Table 3, comparing with those of the first preferred embodiment, as presented in Table 1.

TABLE 3
Characteristics of the dye-sensitized solar cell in accordance with
the second preferred embodiment of the present invention

| | CONC | Time | Size | Counter | Jsc | Voc | | η |
|---|---|---|---|---|---|---|---|---|
| Dye material | (M) | (min) | (cm²) | electrode | (mA/cm²) | (V) | FF | (%) |
| DI water:SCC | 0.004 | 10 | 4 | Pt | 0.66 | 0.42 | 0.47 | 0.127 |
| DI water:SCC | 0.004 | 15 | 4 | Pt | 1.05 | 0.43 | 0.38 | 0.168 |
| DI water:SCC | 0.004 | 20 | 4 | Pt | 1.05 | 0.42 | 0.41 | 0.182 |
| DI water:SCC | 0.004 | 25 | 4 | Pt | 1.26 | 0.42 | 0.33 | 0.177 |
| DI water:SCC | 0.004 | 30 | 4 | Pt | 0.55 | 0.43 | 0.39 | 0.092 |

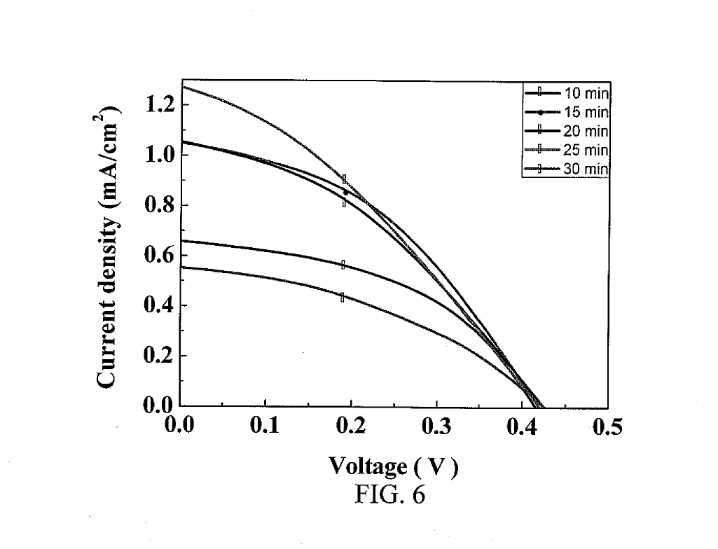

FIG. 6 shows a chart illustrating operating current densities in relation to operating voltages of the dye-sensitized solar cells in accordance with the second preferred embodiment of the present invention. Referring to FIGS. 1, 2 and 5, in forming the thin photosensitive dye layer 40, the 4 cm² working area of the first electrode layer 20a and the semiconductor layer 30 of the dye-sensitized solar cell 1 is treated by ultrasound for 10, 15, 20, 25 and 30 minutes, respectively. The characteristics of operating current densities in relation to operating voltages of the dye-sensitized solar cell 1 are five curves as best shown in FIG. 6. Short circuit current densities (Jsc) and open circuit voltages (Voc) for the dye-sensitized solar cell 1 can be extracted from the five curves in FIG. 6 and the data are presented in Table 3.

Referring again to FIGS. 3 and 5, the resonant time of ultrasound of the present invention can selectively range from 5 to 20 minutes, from 10 to 20 minutes, from 10 to 30 minutes or from 5 to 30 minutes for continuous or discontinuous (intermittent) ultrasound-treatment to obtain the preferred energy conversion efficiencies of the dye-sensitized solar cell. Furthermore, the size of the working area of the semiconductor layer 30 can be increased according to the needs.

Although the invention has been described in detail with reference to its presently preferred embodiment, it will be understood by one of ordinary skills in the art that various modifications can be made without departing from the spirit and the scope of the invention, as set forth in the appended claims.

What is claimed is:

1. A dye-sensitized solar cell structure comprising:
a first substrate;
a second substrate corresponding to the first substrate;
a first electrode layer formed on the first substrate to provide a working electrode;
a second electrode layer formed on the second substrate to provide a counter electrode;
a semiconductor layer formed on the first electrode layer;
at least one thin photosensitive dye layer formed on a surface of the semiconductor layer; and
an electrolyte layer provided between the semiconductor layer and the second electrode layer;
wherein the surface of the semiconductor layer is treated a predetermined time by ultrasound in forming the thin photosensitive dye layer on the surface of the semiconductor layer.

2. The dye-sensitized solar cell structure as defined in claim 1, wherein the semiconductor layer is immersed in a photosensitive dye solution when the surface of the semiconductor layer is treated by the ultrasound.

3. The dye-sensitized solar cell structure as defined in claim 1, wherein the thin photosensitive dye layer is homogenized by the ultrasound treatment to form a homogenized layer.

4. The dye-sensitized solar cell structure as defined in claim 1, wherein a photosensitive material of the thin photosensitive dye layer is sodium copper chlorophyllin.

5. The dye-sensitized solar cell structure as defined in claim 1, wherein another thin photosensitive dye layer is further formed on the thin photosensitive dye layer.

6. A manufacturing method of a dye-sensitized solar cell comprising:
providing a first substrate on which to form a first electrode layer as a working electrode;
forming a semiconductor layer on the first electrode layer;
forming at least one thin photosensitive dye layer on the semiconductor layer by ultrasound-treating a surface of the semiconductor layer with a predetermined time, thereby facilitating deposition of a photosensitive material on the surface of the semiconductor layer;
providing a second substrate on which to form a second electrode layer as a counter electrode; and
providing an electrolyte layer between the semiconductor layer and the second electrode layer.

7. The manufacturing method of the dye-sensitized solar cell as defined in claim 6, wherein the semiconductor layer is immersed in a photosensitive dye solution when the surface of the semiconductor layer is treated by the ultrasound.

8. The manufacturing method of the dye-sensitized solar cell as defined in claim 6, wherein the photosensitive dye solution is made from a mixture of sodium copper chlorophyllin and deionized water.

9. The manufacturing method of the dye-sensitized solar cell as defined in claim 6, wherein a molar concentration of the photosensitive dye solution is 0.004M.

10. The manufacturing method of the dye-sensitized solar cell as defined in claim 6, wherein the ultrasound is converted into mechanical waves to generate tiny bubbles in the photosensitive dye solution which impact the surface of the semiconductor layer.

11. The manufacturing method of the dye-sensitized solar cell as defined in claim 6, wherein a large working area of the thin photosensitive dye layer is formed on the semiconductor layer.

12. The manufacturing method of the dye-sensitized solar cell as defined in claim 6, wherein another thin photosensitive dye layer is further formed on the thin photosensitive dye layer.
